(19) United States
(12) Patent Application Publication
(10) Pub. No.: US 2003/0093398 A1
(43) Pub. Date: May 15, 2003

(54) Multimedia assembly and method of operating same

(76) Inventor: Joel B. Tabachnik, Boca Raton, FL (US)

Correspondence Address: William F. Prendergast, Brinks Hofer Gilson & Lione, NBC Tower, Suite 3600, P.O. Box 10395, Chicago, IL, 60610, US

(21) Appl. No.: 09/993,978

(22) Filed: Nov. 14, 2001

(51) Int. Cl. G06F 7/00

(52) U.S. Cl. 707/1

(57) ABSTRACT

A multimedia assembly including a multimedia device and a signal generator and a method for updating and distributing the multimedia assembly. The multimedia device has a top surface and bottom surface with at least one of the top and bottom surfaces having printed information located thereon. The multimedia device also includes a memory for storing information generally corresponding to the printed information and a contact point. The signal generator is capable of being placed in communication with the contact point of the multimedia assembly so as to receive a signal from the memory. The signal generator produces a signal corresponding to the information stored in the memory. The memory may be updated by connecting the multimedia device to a docket cradle and downloading information from a computer.

### FIELD OF THE INVENTION

The present invention relates generally to a multimedia assembly and method that are particularly useful for novelty and/or educational purposes. More specifically, the present invention relates to an interactive multimedia assembly and a method for updating information on a multimedia device on multiple occasions and generating a signal generally corresponding to information after each update.

### BACKGROUND

The public's interest in multimedia experiences has been increasing. Devices are presently available that convey information visually or audibly. However, these devices are often expensive and relatively complicated. For example, they often include an LED screen which can add significantly to the cost of manufacture. In addition, these devices may be too complicated for younger children to operate easily. Furthermore, the audio signal generated by the sound source is usually limited to the production of certain preset sounds or information specifically corresponding with the printed subject matter and is often not capable of being readily updated with information. As a result, the devices can only provide information from a single source, and thus do not allow partnering among various entities and content providers.

Prior attempts to produce a low-cost interactive device that can generate sound while being easily updated and simple to use have fallen short. Therefore, there is a need for an improved multimedia device which provides an enhanced experience through the use of a low cost device.

### BRIEF SUMMARY

According to a first aspect of the invention, a method of providing an updated multimedia assembly and related web site is provided. A site is provided having at least one database including data regarding a selected topic. The database is accessible through a network connection and is updated on multiple occasions. A multimedia device is provided having a top surface and bottom surface with at least one of the top surface and the bottom surface having printed information located thereon. The device includes an updatable memory for storing information generally corresponding to the printed information. A contact point and a communications port for connection with the database are also provided on the multimedia device. An audio signal generator is capable of being placed in communication with the contact point of the multimedia device so as to receive a signal from the memory. The audio signal generator includes a speaker to provide an audible signal corresponding to the information stored in the memory. A fee is charged for at least one of (1) access to the at least one database, (2) ownership of the multimedia device, (3) ownership of the audio signal generator, or (4) placing content on the database.

The present invention together with attendant objects and advantages, will be best understood with reference to the detailed description below in connection with the attached drawings.

### BRIEF DESCRIPTION OF THE DRAWINGS

FIG. 1 is a plan view of one embodiment of a multimedia assembly according to the present invention.

FIG. 2 is a perspective view of a portion of the multimedia assembly of FIG. 1.

FIG. 3 is an exploded perspective view of a multimedia device according to one embodiment of the present invention.

FIG. 4 is a plan view of a portion of the multimedia assembly of FIG. 1.

FIG. 5 is a perspective view of a second embodiment of a multimedia assembly according to the present invention.

FIG. 6 is a plan view of a third embodiment of a multimedia assembly according to the present invention.

FIG. 7 is a plan view of a fourth embodiment of a multimedia assembly according to the present invention.

FIGS. 8a-8b are perspective views illustrating the operation of the multimedia assembly of FIG. 7

FIG. 9 is a schematic view of another embodiment of a multimedia assembly according to the present invention.

FIG. 10 is a block diagram illustrating the operation of the multimedia assembly of FIG. 9.

### DETAILED DESCRIPTION

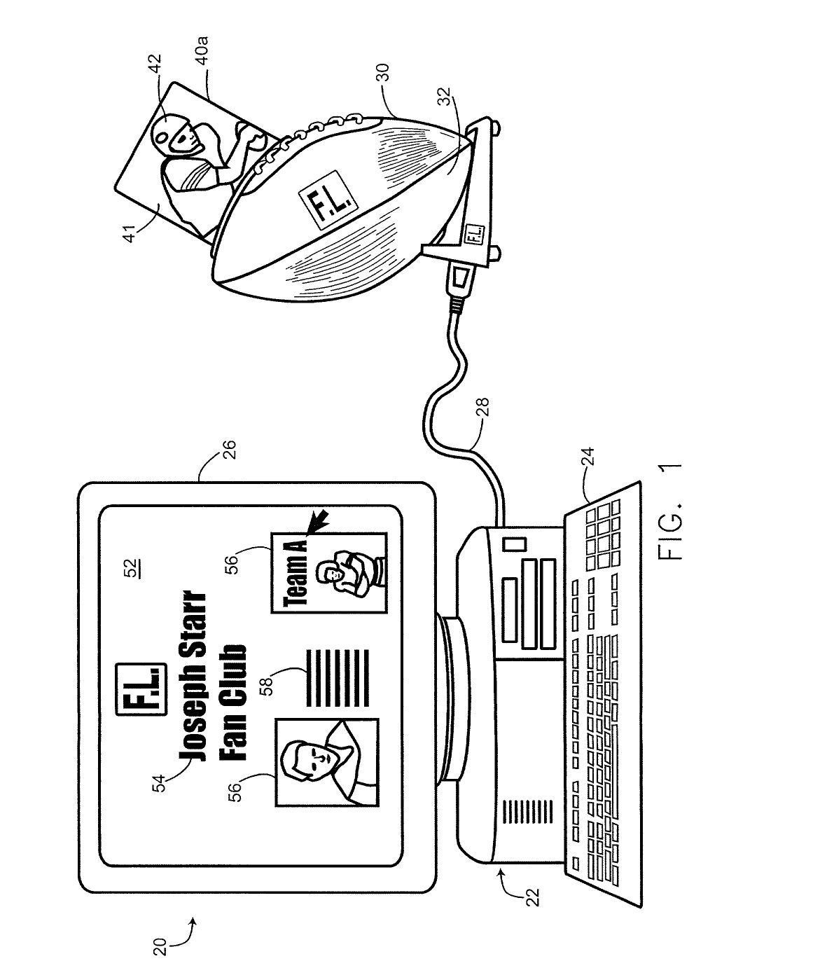

Referring now to the drawings and initially to FIGS. 1-3, a multimedia assembly in accordance with the present invention is shown generally at 20. The multimedia assembly 20 includes a computer 22 having an input device(s), such as a keyboard 24, and a display 26. The computer is preferably connected via utility member 28 to a docking station 30, which is adapted to receive an updatable multimedia device, such as card 40a. Those skilled in the art will appreciate that the docking cradle will alternately be connected to the computer 22 with a wireless connection or may be integrated with the main body of the computer 22.

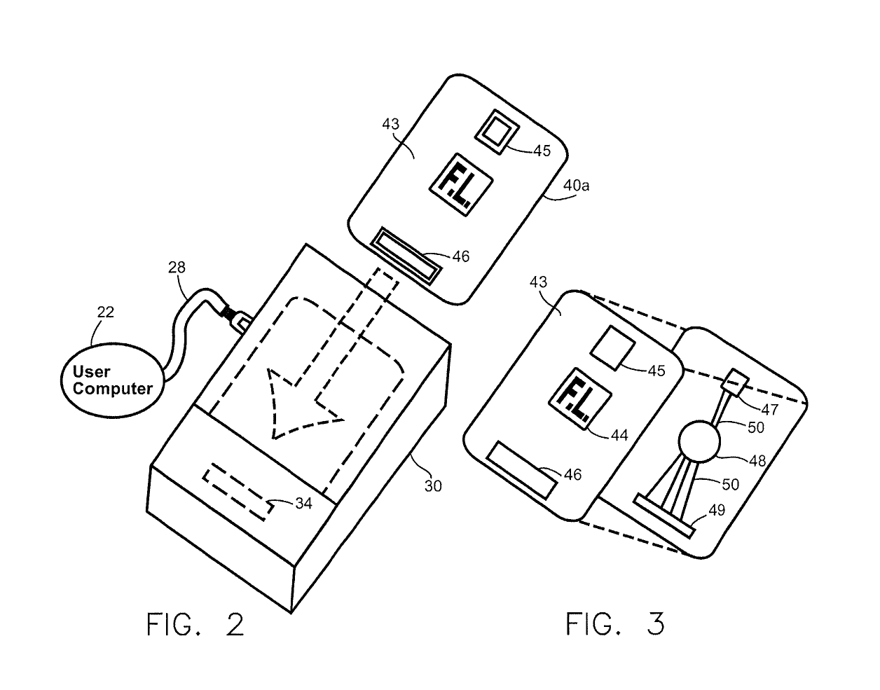

As shown in FIGS. 2-3, the card 40a includes a first portion or front outer surface 41 and a second portion or rear outer surface 43. The rear outer surface 43 includes an aperture 45 for an output contact portion 47, and an aperture 46 for an input contact portion 49. A processor 48 inside the device is electrically connected via the conductive paths 50 to the first and second contact portions 47, 49, respectively.

The docking station 30 includes an aperture (not shown) for receiving the card 40a. The docking station also includes a contact portion 34 that is configured to align generally with contact portion 49 of the card 40a when the card is inserted into the docking station. Information may thus be communicated from the computer 22 to the card 40a and stored on the processor 48.

In the preferred embodiment, the multimedia assembly 20 operates to transfer and update information related to the common theme from the computer 20 to the card 40a. In especially preferred embodiments of the invention, the card 40a and the docking station 30 are formed generally as novelty items that display, either by shape or by images, the common theme.

In the example shown in FIGS. 1-3, the common theme is football. The card 40a includes printed information, such as an image 42, on the front surface related to the common theme, in this example, an image of a football player. The docking station similarly includes an image 32 related to the common theme, in this example, a football field. Those skilled in the art will appreciate other themes, such as team information, athletic event information, and other sports data, e.g., baseball, football, basketball, hockey, soccer data, as well as fictional characters, e.g., movie, comic book, cartoon characters, non-fictional celebrities or persona. Geographical, scientific, political, nutritional, or other educational topics, etc., are also contemplated by the present invention. In the example shown in FIG. 1, information relating to a particular player is transferred from the computer 22 to the card 40a via the docking station 30. The computer screen 50 displays the player's identifying indicia 52, images 56, and other related indicia 58, such as performance statistics or recent memorable quotes.

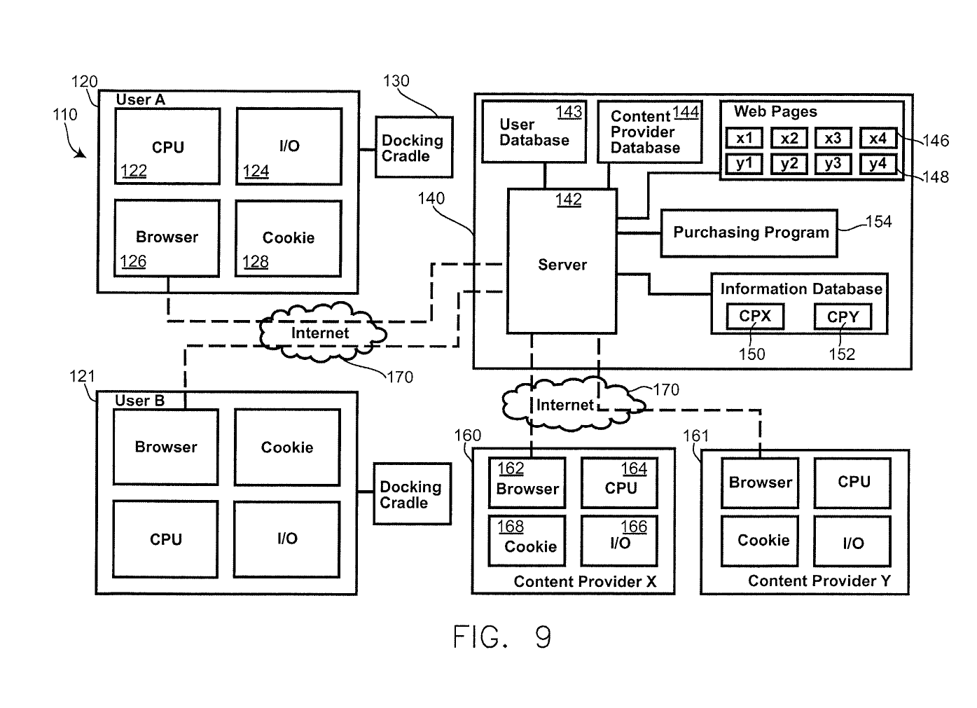

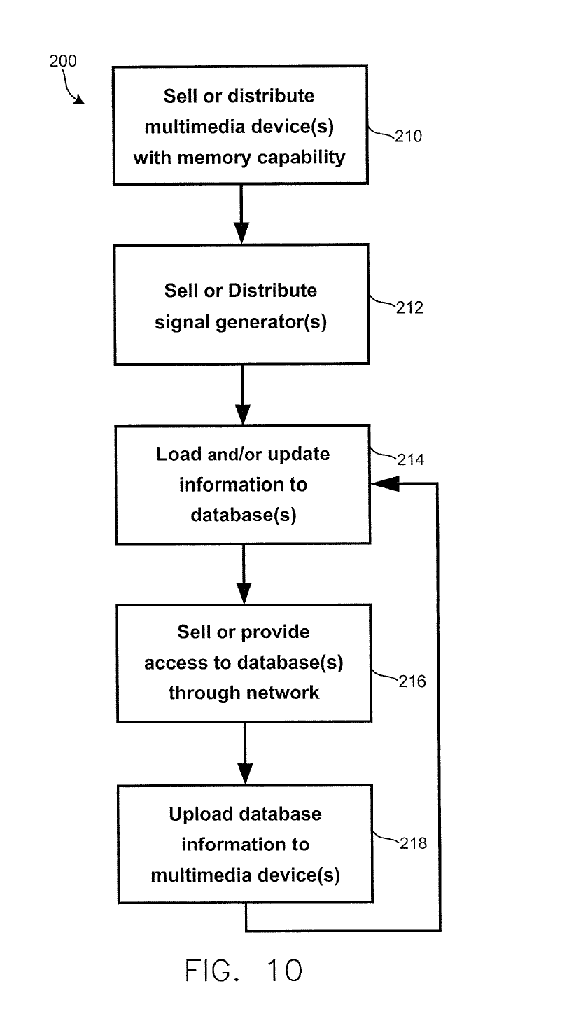

The information may be placed on the computer 22 in any of the ways known in the art. For example, the computer may be a free-standing unit at a store, restaurant, or other place of business that has licensed for the images, photographs, etc., and may sell or otherwise distribute the multimedia devices such as the cards in business promotions, direct sales, etc. Alternately, the information may be placed on the computer by a storage medium, such as a floppy disk or compact disc. In a particularly preferred embodiment, and as described below with reference to FIG. 9, the information may be placed on the computer 22 via a communications network, such as the Internet.

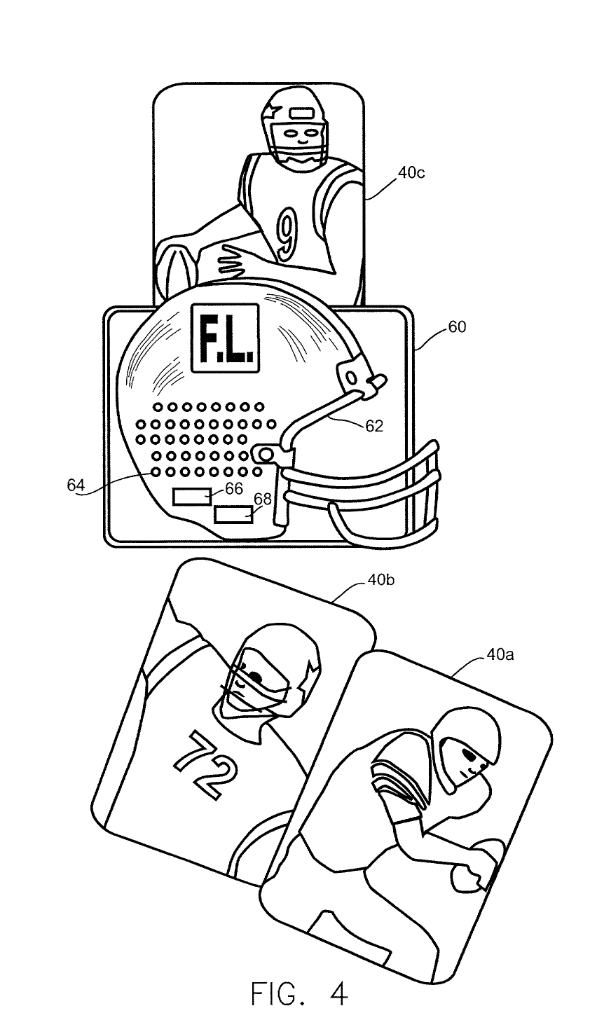

The multimedia assembly also preferably includes a signal generator capable of producing a signal based on the information stored in the processor 48 of the multimedia device. It should also be recognized that the signal produced from the multimedia devices 40a, 40b, 40c can take a wide variety of forms, as recognized by those of ordinary skill in the art, such as audio signals, analog signals or digital signals. In the example shown in FIG. 4, an audio signal generator 60 is adapted to receive any of a collection of multimedia devices 40a, 40b, 40c in an aperture (not shown). The audio signal generator includes a contact portion (not shown) that contacts an output contact portion (not shown) of multimedia device 40c. Internal circuitry allows the audio signal generator to interpret the information stored on the multimedia device 40c and generates an audio signal therefrom. The audio signal is then emitted through a speaker 64. Control buttons 66, 68 may be provided to allow the user to start and stop the audio signal, or to change the volume, etc. One example of the specific circuitry useful with the present invention is illustrated in the copending applications entitled “Talking Novelty Device With Book” filed in the name of Joel B. Tabachnik on Sep. 8, 1999 and bearing Ser. No. 09/391,780, and “Multimedia Card” filed in the name of Joel B. Tabachnik on Nov. 30, 2000, and bearing the Ser. No. 09/727,402, the disclosures of which are hereby incorporated by reference.

The audio signal generator 60 preferably also is formed as a novelty item related to the common theme of the multimedia assembly 20. In the example shown in FIG. 4, the audio signal generator 60 has football decorations and shape 62. It should be recognized that the audio signal generator may be shaped in a wide variety forms as recognized herein and by those of ordinary skill in the art. The audio signal generator 60 is configured to interact with any of the collection of multimedia devices 40a, 40b, 40c. In this example, each of the multimedia devices 40a, 40b, 40c corresponds to a different football player and may store information related to that player.

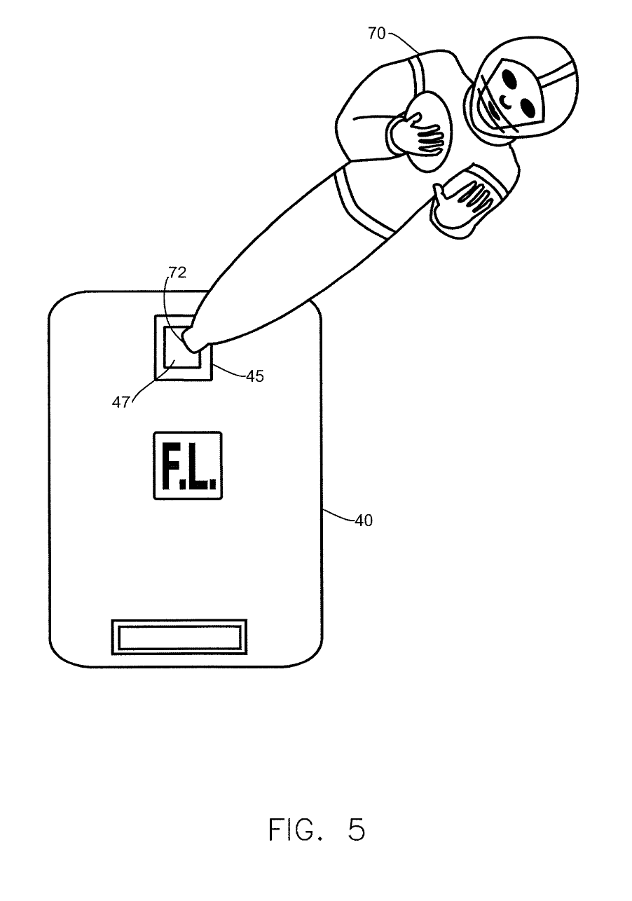

FIG. 5 illustrates an alternate embodiment of an audio signal generator according to the present invention. In this embodiment, the audio signal generator is formed as a pointing member 70. The pointing member 70 may be decorated or shaped as a novelty figure in accordance with the common theme of the multimedia assembly 20. In the example shown in FIG. 5, the pointing member 70 has been formed as a novelty figure having the shape of a football player. The pointing member 70 includes a contact portion 72, which is configured to establish an electrical contact with the output contact portion 47 of the card 40a when the pointing member 70 is correctly positioned relative to the multimedia device.

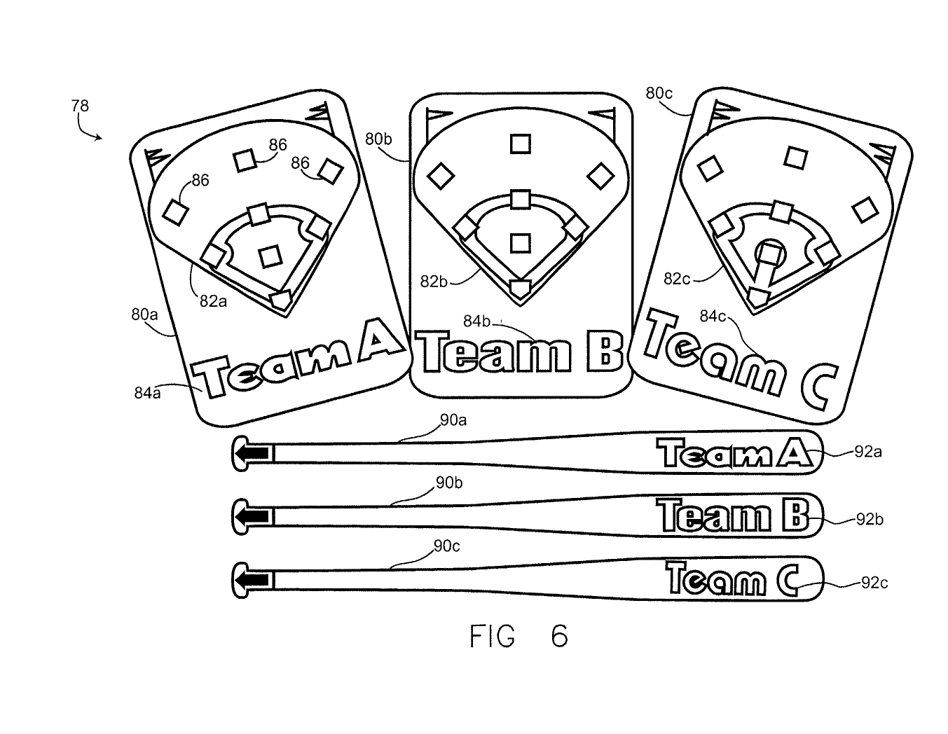

FIG. 6 illustrates an alternate embodiment of a multimedia assembly which includes a plurality of multimedia devices 80a, 80b, 80c, and a plurality of audio signal generators 90a, 90b, 90c. The common theme of this multimedia assembly 78 is baseball. Each multimedia device 80a, 80b, 80c includes an image 82a, 82b, 82c, respectively, and identifying indicia 84a, 84b, 84c, respectively. In the embodiment shown, each image 82a, 82b, 82c corresponds to a playing field of a particular team or team logo, which is identified by the indicia 84a, 84b, 84c, respectively. The collection of audio signal generators 90a, 90b, 90c also includes identifying indicia 92, 92b, 92c corresponding to indicia 84a, 84b, 84c, respectively, thereby providing an opportunity for sale, distribution, or collection of both a set of multimedia devices and a set of audio signal generators. The audio signal generators 90a, 90b, 90c, in this embodiment are each shaped as a sporting element, more particularly, as a baseball bat. Those skilled in the art will appreciate that in other embodiments, depending on the common theme, the sporting element may take other shapes, such as a ball, a golf club, a hockey stick, etc.

The multimedia device 80a includes a plurality of output contact portions 86, which, for example, under the common theme of baseball, may correspond to a separate player position on the field (image 82a) for a particular baseball team (indicia 84a). The audio signal generator 90a has a contact portion 94 capable of establishing an electrical contact with each output contact portion 86 and generating an audio signal sounded through a speaker (not shown). The audio signal generated is based upon information previously uploaded to the multimedia device 80a about each particular player of the particular team.

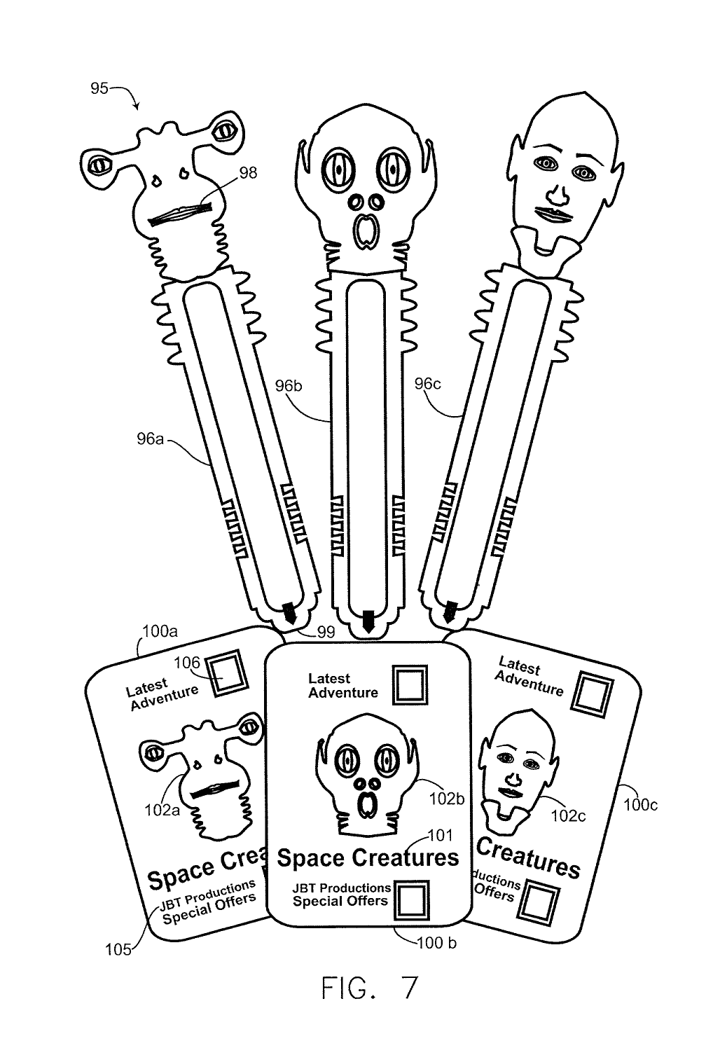

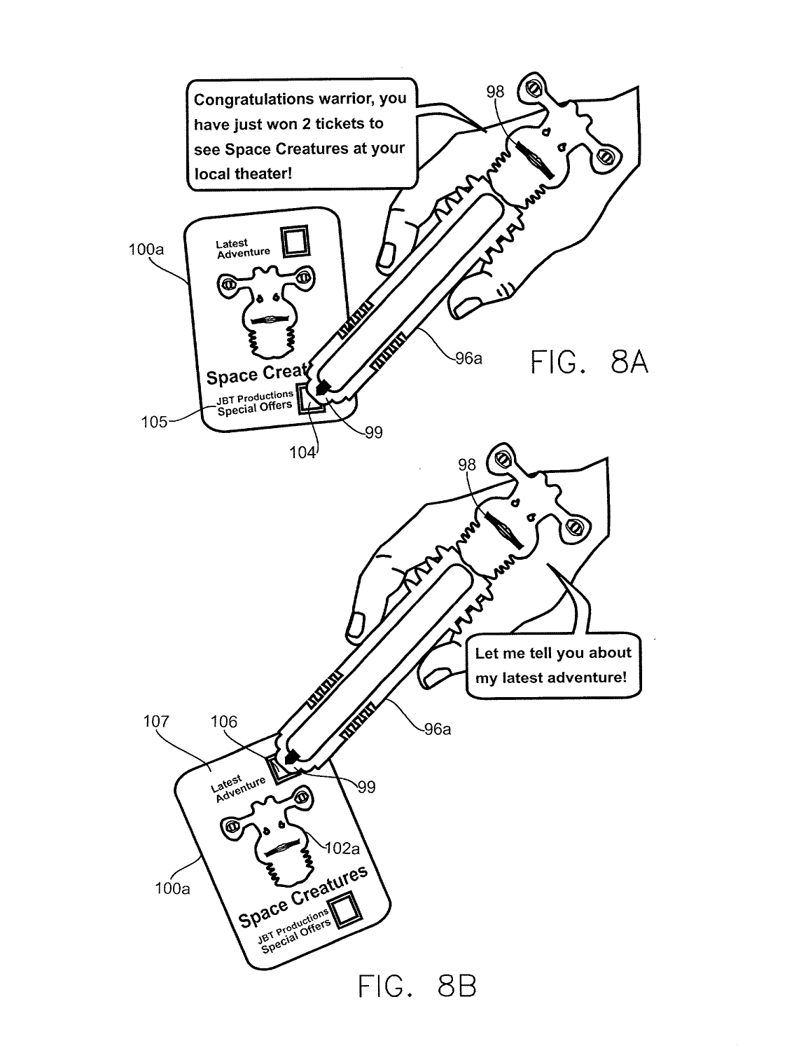

FIGS. 7 and 8 illustrate another alternate embodiment of a multimedia assembly 95 including a plurality of collectible audio signal generators 96a, 96b, 96c, and a plurality of multimedia devices 100a, 100b, 100c. In this embodiment, the common theme is based on fictional characters, such as characters in a television show or movie, which preferably is identified with printed information, such as indicia 101, on each of multimedia devices 100a, 100b, 100c. Each audio signal generator 96a, 96b, 96c is formed at least partially in the shape of a particular fictional character, and each multimedia device has a corresponding image 102a, 102b, 102c, respectively, of that character.

In the embodiment shown in FIGS. 7 and 8a-8b, each multimedia device has two output contact portions. A first contact portion 104 is associated with marketing indicia 105 representing a corporate logo or other marketing information. A second contact portion 106 is associated with theme-related indicia 107. As illustrated in FIG. 8a, when a contact portion 99 of the audio signal generator 96a is placed in contact with first contact portion 104, the audio signal generator 96a produces an audio signal emanating from a speaker 98. The content of the audio signal is preferably related to marketing interests of the entity identified by the marketing indicia 105. As shown in FIG. 8b, when the contact portion 99 of the audio signal generator 96a is placed in contact with first contact portion 104, the audio signal produced and emanating from speaker 98 relates to the common theme, in this case, an episode of the fictional story related to the character identified by image 102b.

Turning now to FIG. 9, another particularly preferred embodiment of a multimedia assembly is shown generally at 110. In this embodiment, updatable information may be supplied from third-parties and downloaded by end-users via a communications network, such as the Internet. The multimedia assembly 110 includes one or more user computers 120, 121, linked to a main computing system 140, and one or more content provider computers 160, 161, also linked to the main computing system 140. In the preferred embodiment shown, the user computers generally include a microprocessor 164, input and output devices 124, and a web browser 126, and are able to accept cookies 128, as is conventional in the art. Similarly, the content provider computers generally include a web browser 162, a microprocessor, input and output devices 166, and may accept cookies 128. While the exemplary system shown includes two user computers and two content-provider computers, those skilled in the art will appreciate that the assembly may include any number of such computers as needed by the number of users and content-providers wishing to access the assembly. The multimedia assembly also preferably includes a docking cradle 130 associated with each user computer, and one or more multimedia devices (not shown) and audio signal generators (not shown).

The central computing system 140 includes a server 142. The server 142 is accessible by the user browser 126 and the content provider browser 162 through a communications network 170 such as the Internet. The connection between the user computer 120, 121, the content provider computers 160, 161, and the main computing system 140 could be wired or wireless. Communications can be provided, for example, through personal communication systems, microwaves, satellites, and/or over landlines. While other types of communications networks could be used, the Internet allows a user to access the World Wide Web (“the web”), a unique distributed database designed to give wide access to a large universe of data.

The central computing system 140 preferably includes a user database 143, which keeps information about particular users, such as user contact information, usage information, latest sign-on and latest download information, etc. Similarly, content provider database 144 contains information about particular content providers. The information in the user database 143 and the content provider database 144 may be used by the purchasing program 154 to charge a fee for use of the system 140 by the content providers and/or the users in accordance with a method of business operation described more fully below.

The central computing may also include electronic documents known as web pages 146, 148. The pages may be constructed in any one of a variety of formatting conventions, such as Hyper Text Markup Language (HTML), and can include multimedia information that is downloaded to an associated multimedia card. In the example shown, the web pages 146 correspond to material provided by content provider X, and the web pages 148 correspond to material provided by content provider Y. Further information may be stored in the form of information databases 150, 152, corresponding to information uploaded to the system by content provider X and content provider Y, respectively. The web pages 148, 150 interact with the information databases 150, 152, respectively, to present information to the user, for example, to user A accessing server 142 via browser 126. For example, the web pages 144 may include templates for fan club pages for a sports persona, with the database 150 providing data for inserting the most recent performance statistics into the template.

To access data stored in the server 142, a user would log onto the server 142 preferably via the communications network 170, e.g., the Internet. A security feature such as a password may be used to provide access to the data. Once the user has accessed the server 142, a Web page would be displayed having an interface that would provide access to the additional information that may be downloaded. The interface is linked in a conventional manner to data stored in the server on the selected subject. By clicking on the interface corresponding to a particular topic, the user would be led to the information that they desire to download, e.g., information relevant to a team, player, fictional character, educational facts, etc. The selected information is then downloaded from the server 142 via the docking station 130 to the multimedia card (not shown).

The content provider(s) may upload information to the database(s) 150, 152 on multiple occasions, preferably on a regular basis. For example, where the common theme is a sports player, the player's statistics may be updated every week. The main computing system 140 is preferably adapted to track which of the updates a particular user has viewed and/or uploaded. This may be accomplished by placing a cookie 128 on a user's computer 120, and/or by keeping track of a user's logins in the user database 143. In the preferred embodiment, the user may be instructed which of the uploads have not yet been transferred to a multimedia device. In another preferred embodiment, data regarding a selected topic is only available for a limited time.

In FIG. 10, one preferred embodiment of a method of marketing and operating the multimedia assembly 110 is shown generally at 200. First, one or more multimedia devices with memory capability are sold or otherwise distributed (at 210) to users of the multimedia assembly, such as consumers. Such sale or distribution may be performed by various entities, for example, by trademark and copyright owners of the content of a common theme, or by their licensees. These entities may include sports leagues, production studios, educational institutions, toy manufacturers, general marketers, etc. Likewise, one or more signal generator(s) may be sold or otherwise distributed (at 212) to users by the same entities, or by different entities than those selling or distributing the multimedia devices. Where different entities sell or distribute the signal generators, the entities may partner with, cross-license with, or otherwise contract with the entities selling or distributing the multimedia devices. Next, information that may be stored using the memory capability of the multimedia devices may be loaded or updated (at 214) to information database(s) 150, 152 (FIG. 9) by the content provider(s). Again, the content provider(s) may be the same entity or a different entity than those selling or distributing the multimedia devices and the audio signal generators. Next, the central computing system administrator sells or otherwise provides access (at 216) to the information database(s) 150, 152 to the user(s). The system administrator may be the same or different entity as those selling or distributing multimedia devices and/or signal generators, and those loading or updating information to the database(s). Finally, the user(s) uploads (at 218) information to the multimedia device(s) for later use with an appropriate signal generator.

The content provider may continue to update the information on multiple occasions, preferably on a regular basis. The user may upload the updated information to the multimedia device, and then later access the information with a signal generator as he or she wishes.

The central computing system 140 is preferably operated by a system administrator who may market the system to both content providers and end users, such as consumers. The system administrator may solely be in the business of operating the system, or may also be involved with selling, licensing or distributing multimedia devices, audio signal generators and/or docking cradles. The content providers will typically be interested in marketing information related to a common theme or themes, and may also be in the business of selling, licensing, or distributing any or all of multimedia devices, signal generators, and/or docking cradles related to the common theme(s).

For example, where the common theme is football, the content provider may be the owner of the football team or league. Alternately, the content provider may be a licensee of the football team or league, for example, a company that sells sports paraphernalia, or even a fast food restaurant that wishes to incorporate a football theme in its marketing strategy. Similarly, where the common theme is related to fictional characters, the content provider may be the actual copyright holder of the fictional content, or may be a licensee, such as a movie production company or a theatre chain. In an alternate embodiment, the content provider may be an agent hired by the owner or licensee to operate the content provider system.

The system may be a portion of an overall and integrated marketing strategy among more than one entity. The strategy may include the sale or distribution of multimedia devices, signal generators, updated information, and optional docking cradles. For example, a fast food chain may wish to partner with a sports league, a toy manufacturer, and computer services company to market both the fast food chain and the sports league. In this example, the fast food company may distribute, with the purchase of a food product, updatable multimedia devices centered around the common theme of football with the purchase of a food product by the user. The toy manufacturer may sell docking cradles and/or audio signal generators, all having images or shapes, such as a novelty figure, related to the football theme, under a license from the sports league. The computer service company may be hired to provide updated information related to the common theme of football under a license from the sports league. The computer service company would then approach the system administrator of the central computing system 140 and pay a fee for placing updated content on the central computer system 140. Likewise, the user, now owner of a multimedia device distributed by the fast food company and an audio signal generator and docking cradle purchased from the toy manufacturer, may access central computing system 140 through the user computer 120, and may upload the information provided by the content provider. This service may be free to the user, or may require a fee. The user may be required to register some identifying information, which may be sold or distributed to any of the entities described above or to others for the purpose of further marketing.

Those skilled in the art will recognize that the example described above is just one of numerous examples of operation of the system 110 in accordance with the present invention. The invention may be embodied in other specific forms without departing from the spirit of the invention. For instance, in the above-described example, audio signal generators may also be distributed along with the multimedia devices by the fast food chain. Alternately, the audio signal generators may be distributed by the sports league at sporting events, or may be sold over the internet by the system administrator. In other embodiments, all components may be distributed by the sports league, or all may be distributed by the fast food restaurant under a license of the sports league. It should be readily understood that those entities selling, distributing, or licensing components, and their combination thereof, are numerous and many are envisioned in accordance with the invention.

The embodiments described above and shown herein are illustrative and not restrictive. The scope of the invention is indicated by the claims rather than by the foregoing description and attached drawings. The invention may be embodied in other specific forms without departing from the spirit of the invention. For example, the cards may include a wide variety of information such as educational, entertainment or sports information. Within sports information, for example, league, team or player information may be provided as recognized by those of ordinary skill in the art. Also, the specific circuitry used to generate an audible signal could include a wide variety of known constructions and structural configurations without departing from the claimed invention. Accordingly, these and any other changes which come within the scope of the claims are intended to be embraced herein.

I claim:

1. A method of providing an updated multimedia assembly and related web site comprising:
(a) providing a site having at least one database including data regarding a selected topic, the database accessible through an a network connection;
(b) updating the at least one database on multiple occasions;
(c) providing a multimedia device having a top surface and bottom surface with at least one of the top surface and the bottom surface having printed information located thereon, and the device including an updatable memory for storing information generally corresponding to the printed information, a contact point and a communications port for connection with the database;
(d) providing an audio signal generator capable of being placed in communication with the contact point of the multimedia device so as to receive a signal from the memory and including a speaker to provide an audible signal corresponding to the information stored in the memory; and
(e) charging a fee for at least one of (1) access to the at least one database (2) ownership of the multimedia device (3) ownership of the audio signal generator and (4) placing content on the database.

2. The method of claim 1 further comprising updating the database on a regular basis.

3. The method of claim 1 wherein the data regarding a selected topic includes data about a fictional character.

4. The method of claim 3 wherein the data about the fictional character includes data corresponding to the voice of the fictional character.

5. The method of claim 4 wherein the data corresponding to the voice of a fictional character is available only on the site.

6. The method of claim 1 wherein the data regarding a selected topic includes sports data.

7. The method of claim 6 wherein the sports data includes team information.

8. The method of claim 7 wherein the sports data includes player information.

9. The method of claim 6 wherein the sports data includes audio information corresponding to a particular portion of an athletic event.

10. The method of claim 1 wherein the data regarding a selected topic is available for a limited time.

11. The method of claim 1 wherein the multimedia device is one of a collection of generally related multimedia devices.

12. The method of claim 1 wherein updating the database is performed at least in part by a third-party content provider.

13. A multimedia assembly comprising:
(a) a card having a top surface and bottom surface with at least one of the top surface and the bottom surface having printed information located thereon and a contact point, the card having a memory for storing information generally corresponding to the printed information;
(b) the audio signal generator capable of being placed in communication with the contact point of the card so as to receive a signal from the memory and the audio signal generator including a speaker to provide an audible signal corresponding to the information stored in the memory, the audio signal generator generally shaped in the form of a novelty figure.

14. The multimedia assembly of claim 13 wherein the audio signal generator further comprises a memory for storing information.

15. The multimedia assembly of claim 13 wherein the novelty figure generally relates to the printed information.

16. The multimedia assembly of claim 15 wherein the novelty figure comprises a sporting element.

17. The multimedia assembly of claim 15 wherein the sporting element comprises a ball.

18. The multimedia assembly of claim 17 wherein the novelty figure comprises fictional character.

19. The multimedia assembly of claim 18 wherein the novelty figure comprises a non-fictional personality.

20. The multimedia assembly of claim 15 wherein the novelty figure comprises a logo.

21. The multimedia assembly of claim 20 wherein the logo comprises an athletic team logo.

22. The multimedia assembly of claim 21 wherein the novelty figure comprises a food item.

23. A multimedia assembly comprising:
(a) a multimedia device having a top surface and bottom surface with at least one of the top surface and the bottom surface having printed information located thereon, and the device including an updatable memory for storing information generally corresponding to the printed information and a communications port for connection to a database; and
(b) a docking cradle capable of being operatively connected to the communications port, the docking cradle generally shaped in the form of a novelty figure.

24. The multimedia assembly of claim 23 further comprising an audio signal generator capable of being connected to the multimedia device so as to receive a signal from the memory and the audio signal generator including a speaker to provide an audible signal corresponding to the information stored.

25. The multimedia assembly of claim 23 wherein the novelty figure generally relates to the printed information.

26. The multimedia assembly of claim 25 wherein the novelty figure generally relates to a fictional character.

27. The multimedia assembly of claim 25 wherein the novelty figure generally relates to a logo.

28. The multimedia assembly of claim 27 wherein the logo relates to an athletic team.

29. The multimedia assembly of claim 27 wherein the logo relates to a corporation.

30. The multimedia assembly of claim 26 wherein the audio signal generator is generally shaped in the form of a novelty figure.

31. The multimedia assembly of claim 30 wherein the audio signal generator is shaped to generally correspond to the shape of the docking cradle.
